(19) United States
(12) Patent Application Publication
(10) Pub. No.: US 2016/0148554 A1
(43) Pub. Date: May 26, 2016

(54) DISPLAY APPARATUS AND CONTROLLING METHOD THEREOF

(71) Applicant: SAMSUNG ELECTRONICS CO., LTD., Suwon-si (KR)

(72) Inventors: Dae-sung LIM, Suwon-si (KR); Mun-gyu KONG, Yongin-si (KR); Deok-jin YANG, Suwon-si (KR)

(73) Assignee: SAMSUNG ELECTRONICS CO., LTD., Suwon-si (KR)

(21) Appl. No.: 14/923,857

(22) Filed: Oct. 27, 2015

(30) Foreign Application Priority Data
Nov. 24, 2014 (KR) 10-2014-0164657

(51) Int. Cl. G09G 3/20

(52) U.S. Cl. CPC G09G 3/2003; G09G 2320/066

(57) ABSTRACT

A display apparatus and a method of controlling the display apparatus are provided. The display apparatus includes a display unit configured to include a display panel configured to be curved at a curvature occurring within a preset range and a controller configured to control the display unit to compensate for an image quality of each area of the display panel based on the curvature of the display panel. Therefore, a user uses a display apparatus capable of controlling a curvature effect.

### CROSS-REFERENCE TO RELATED APPLICATIONS

This application claims priority benefit from Korean Patent Application No. 10-2014-0164657, filed on Nov. 24, 2014, in the Korean Intellectual Property Office, the disclosure of which is incorporated herein by reference in its entirety.

### BACKGROUND

1. Field

Apparatuses and methods consistent with the present disclosure relate to a display apparatus and a controlling method thereof, and more particularly, to a display apparatus capable of controlling a curvature effect of a display panel that is curved at a preset curvature, and a controlling method thereof.

2. Description of the Related Art

The development of electronic technologies has brought the development and distribution of various types of electronic devices. Also, a user easily encounters a large display apparatus, such as a Television (TV) or the like, and a small display apparatus such as a smartphone, a tablet PC, or the like, in everyday lives.

A display apparatus including a curved display panel has been recently developed and distributed. The curved display panel may not directly reflect light to a user and may increase an immersion.

Also, a bendable display apparatus capable of controlling a curved degree of a display panel has also been developed. The bendable display apparatus may provide an optimum image quality according to the number of uses using the bendable display apparatus and an angle. Since an element for controlling the curved degree of the display panel is needed, a price of the bendable display apparatus rises.

Therefore, although the curved degree of the display panel is not physically controlled, a technology for differently showing the curved degree of the display panel is needed.

Also, when the curved degree of the display panel is controlled, there is a need for a technology for controlling an image quality of the display panel so as to enable the image quality to be appropriate for the curved degree of the display panel.

### SUMMARY

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides a display apparatus capable of controlling a curvature effect of a display panel that is curved at a curvature occurring within a preset range, and a controlling method thereof.

According to an aspect of the present disclosure, a display apparatus includes a display unit comprising a display panel configured to be curved at a preset curvature, and a controller to control the display unit to compensate for an image quality of at least one area of the display panel based on the curvature of the display panel.

The controller may compensate for a current value of pixels included in the display panel to control brightness of the at least one area of the display panel based on the curvature of the display panel.

The display apparatus may further include a backlight unit BLU) to provide backlight to the display panel, and a backlight driver to drive the BLU. The controller may control the backlight driver to control brightness of the at least one area of the display panel based on the curvature of the display panel.

The controller may control red (R), green (G), and blue (B) values of pixels included in the display panel in response to the brightness of the at least one area of the display panel.

The controller may control the display unit so as to adjust brightness of a central area of the display panel to be brightest and adjust brightness of the other areas of the display panel to be darker as being farther away from the central area of the display panel.

The display apparatus may further include a user sensor configured to sense a user of the display unit. The controller may control brightness of the at least one area of the display panel according to a position of the user sensed through the user sensor.

The controller may control brightness of the at least one area of the display panel according to user settings.

The controller may control brightness of the at least one area of the display panel according to a type of a content displayed on the display unit.

The controller may divide the display panel into a plurality of areas in a vertical direction and control brightness of the at least one area of the plurality of areas.

According to another aspect of the present disclosure, a method of controlling a display apparatus includes calculating a parameter value for compensating for an image quality of the at least one area of a display panel configured to be curved at a curvature occurring within a preset range, based on the curvature of the display panel, and controlling the display panel according to the calculated parameter value.

The controlling of the display panel may include compensating for a current value of a plurality of pixels included in the display panel to control brightness of the at least one area of the display panel based on the curvature of the display panel.

The controlling of the display panel may include controlling a backlight driver configured to drive a BLU, so as to enable the BLU to provide brightness of the at least one area of the display panel based on the curvature of the display panel.

The method may further include controlling R, G, and B values of pixels included in the display panel in response to the brightness of the at least one area of the display panel.

The controlling of the display panel may include controlling brightness of a central area of the display panel to be brightest and controlling brightness of the other areas of the display panel to be darker as being farther away from the central area of the display panel.

The method may further include sensing a user of the display panel. The controlling of the display panel may include controlling brightness of the at least one area of the display panel according to a position of the sensed user.

The controlling of the display panel may include controlling brightness of the at least one area of the display panel according to user settings.

The controlling of the display panel may include controlling brightness of the at least one area of the display panel according to a type of a content displayed on the display apparatus.

The controlling of the display panel may include dividing the display panel into a plurality of areas in a vertical direction and controlling brightness of the at least one of the plurality of areas.

According to various exemplary embodiments of the present disclosure as described above, there may be provided a display apparatus capable of controlling a curvature effect of a display panel that is curved at a curvature occurring within a preset range, and a controlling method thereof.

Additional and/or other aspects and advantages of the disclosure will be set forth in part in the description which follows and, in part, will be apparent from the description, or may be learned by practice.

### BRIEF DESCRIPTION OF THE DRAWINGS

The above and/or other aspects of the present disclosure will be more apparent by describing certain exemplary embodiments of the present disclosure with reference to the accompanying drawings, in which:

FIG. 1 illustrates a display apparatus including a curved display panel according to an exemplary embodiment of the present disclosure;

FIG. 2 illustrates a curvature of a display unit according to an exemplary embodiment of the present disclosure;

FIG. 3 is a block diagram of a simple structure of a display apparatus according to an exemplary embodiment of the present disclosure;

FIG. 4 is a block diagram of a detailed structure of a display apparatus according to an exemplary embodiment of the present disclosure;

FIGS. 5A, 5B, 5C, 6A, 6B, 7A and 7B illustrate brightness of each area of a curved display panel that is controlled, according to an exemplary embodiment of the present disclosure;

FIGS. 8A, 8B, 8C and 8D illustrate brightness of each area of a display pane that is controlled according to a position of a user, according to an exemplary embodiment of the present disclosure;

FIG. 9 illustrates a structure of a display unit according to an exemplary embodiment of the present disclosure;

FIG. 10 illustrates a method of applying a pressure according to an exemplary embodiment of the present disclosure; and

FIG. 11 is a flowchart of a method of controlling a display apparatus according to an exemplary embodiment of the present disclosure.

### DETAILED DESCRIPTION

Certain exemplary embodiments of the present disclosure will now be described in greater detail with reference to the accompanying drawings.

In the following description, same drawing reference numerals are used for the same elements even in different drawings. The matters defined in the description, such as detailed construction and elements, are provided to assist in a comprehensive understanding of the disclosure. Thus, it is apparent that the exemplary embodiments of the present disclosure may be carried out without those specifically defined matters. Also, well-known functions or constructions are not described in detail since they would obscure the disclosure with unnecessary detail.

Although the terms first, second, etc. may be used herein to describe various elements, these elements should not be limited by these terms. These terms are only used to distinguish one element from another element.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this disclosure, specify the presence of stated features, integers, steps, operations, elements, and/or components, but do not preclude the presence or addition of one or more other features, integers, steps, operations, elements, components, and/or groups thereof.

In exemplary embodiments of the present disclosure, a “module” or a “unit” may perform at least one function or operation and may be embodied as hardware or software or as a combination of hardware and software. Also, a plurality of “modules” or a plurality of “units” may be integrated into at least one module except a “module” or a “unit” that may be embodied as particular hardware, to be embodied as at least one processor (not shown).

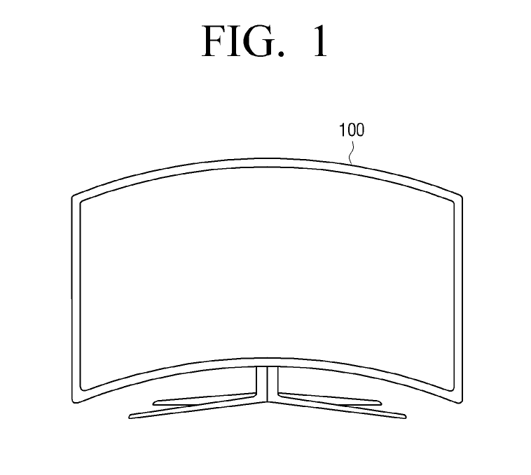

FIG. 1 illustrates a display apparatus 100 including a curved display panel according to an exemplary embodiment of the present disclosure. FIG. 1 illustrates the display apparatus 100 as a TV, but this is only an exemplary embodiment. Therefore, the display apparatus 100 may be realized as various types of electronic devices such as an electronic blackboard, an electronic table, a large format display (LFD), a smartphone, a tablet PC, a desktop PC, a notebook PC, etc. including displays.

The curved display panel refers to a flat state display panel, of which left and/or right sides are curved so as to have a preset curvature or curvature radius. Here, the curvature or curvature radius is a value that may represent a curved degree at each point of a curved surface. The curvature is an inverse number of the curvature radius. In other words, as the curvature radius is large, a curve of the curved surface becomes gentle. As the curvature radius is small, the curve of the curved surface becomes sharp. On the contrary, as the curvature is large, the curve of the curved surface becomes sharp. As the curvature is small, the curve of the curved surface becomes gentle and thus becomes flat when the curvature is 0.

Therefore, in the present disclosure, the curvature and the curvature radius are defined as values that may represent curved degrees at respective points of the curved surface.

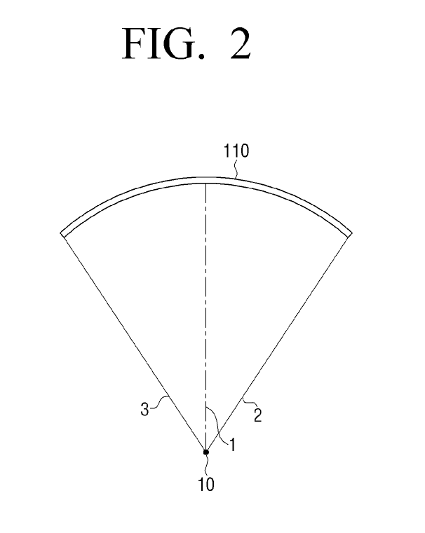

In detail, as shown in FIG. 2, a display unit 110 of the display apparatus 100 may be curved to have a preset curvature and thus may correspond to a part of a circle having one center 10. Therefore, lines 1, 2, and 3 are diameters having the same lengths and meet at the center 10 of the circle including the display unit 110. Here, the line 1 is positioned in a direction perpendicular to a tangent of a central area of the display unit 110, the line 2 is positioned in a direction perpendicular to a tangent of a right end of the display unit 110, and the line 3 is positioned in a direction perpendicular to a tangent of a left end of the display unit 110.

In other words, radiuses 1, 2, and 3 of a circle having a center denoted by reference numeral 10 are curvature radiuses of the corresponding circle. Therefore, a large curvature radius may indicate that a part of the curved display unit 110 meets a circle having a relatively large radius. As a result, a large curvature radius of the display unit 110 means that a curve of a curved surface of the display unit 110 is gently curved.

The display apparatus 100 may include a display panel that is curved at a preset curvature. In other words, the display apparatus 100 may include a display panel that is curved at an arbitrary curvature to be fixed.

However, this is only an exemplary embodiment, and thus the display apparatus 100 may change a curvature or a curvature radius to reduce a distortion of a viewing angle when a user views a 3-dimensional (3D) image. In other words, according to a viewing distance of the user, a position of the user, etc., the display apparatus 100 may calculate an appropriate curvature or curvature radius and determine a curved degree of a display panel to control the display panel. A detailed method of changing a curvature through a display apparatus will be described later.

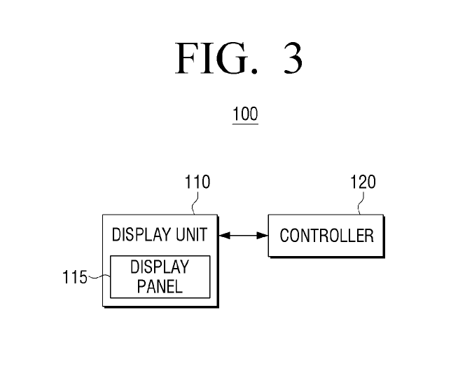

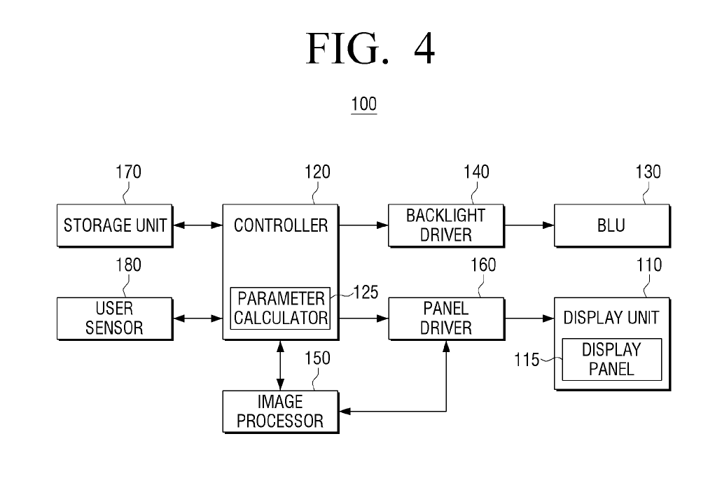

A structure of a display apparatus 100 including a display panel that is curved at a preset curvature will now be described in detail with reference to FIGS. 3 and 4.

FIG. 3 is a block diagram of a simple structure of a display apparatus 100 according to an exemplary embodiment of the present disclosure. As shown in FIG. 3, the display apparatus 100 includes a display unit 110 and a controller 120.

The display unit 110 may include a display panel 115 that may be curved at a curvature occurring within a preset range. As described above, the curvature refers to a value that may represent a curved degree at each point of a curved surface.

The display panel 115 included in the display unit 110 may include a plurality of pixels. Here, the plurality of pixels include red (R), green (G), and blue (B) pixels. In other words, pixels including R, G, and B pixels may be arranged in a plurality of rows and a plurality of columns to form the display panel 115. In this case, the display panel 115 may be realized as various types of display units such as a liquid crystal display panel (LCDP), a plasma display panel (PDP), an organic light-emitting diode (OLED), a vacuum fluorescent display (VFD), a field emission display (FED), an electro luminescence display (ELD), etc.

The controller 120 is an element that controls an overall operation of the display apparatus 100. In particular, the controller 120 may control the display unit 110 to compensate for an image quality of each area of the display panel 115 based on a curvature that is a curved degree of the display unit 110.

The controller 120 may control brightness of each area of the display panel 115 based on the curvature of the display panel 115 to compensate for an image quality of the display panel 115.

In detail, when the display panel 115 does not additionally include a backlight unit (BLU) like an OLED panel, the controller 120 may compensate for a current value of each pixel included in the display panel 115 to control brightness of each area of the display panel 115.

When the display panel 115 additionally includes the BLU like an LCDP or an LED panel, the controller 120 may control a backlight driver to control brightness of each area of the display panel 115.

For example, the controller 120 may control the backlight driver so as to enable brightness of the BLU to be brightest in a central area of the display panel and so as to enable the brightness of the BLU to be darker as being far away from the central area of the display panel 115.

The controller 120 may control R, G, and B values of pixels included in the display panel 115 in response to the brightness of each area of the display panel 115.

The controller 120 may provide brightness of each area of the display panel 115 according to a default value pre-stored in the display apparatus 100 but may provide the brightness of each area of the display panel 115 according to user settings.

In particular, the controller 120 may control to provide different brightness to areas of the display panel 115 so as to increase a curved effect of the display panel 115 that is curved at a preset curvature.

The controller 120 may also control to provide different brightness to the areas of the display panel 115 according to types of contents displayed on the display panel 115. In other words, when a content is displayed on the display panel 115 having a large curvature so as to maximize a display effect, the controller 120 may control the display panel 115 so as to enable brightness of the central area of the display panel 115 to be brighter and so as to enable brightness of the display panel 115 to be darker as being far away from the central area of the display panel 115.

Alternatively, when a content is displayed on the display panel 115 having a small curvature so as to maximize a display effect, the controller 120 may control the display panel 115 so as to enable the brightness of the central area of the display panel 115 to be dark and so as to enable the brightness of the display panel 115 to be brighter as being far away from the central area of the display panel 115.

FIG. 4 is a block diagram of a detailed structure of a display apparatus 100 according to an exemplary embodiment of the present disclosure. As shown in FIG. 4, the display apparatus 100 may further include a BLU 130, a backlight driver 140, an image processor 150, a panel driver 160, a storage unit 170, and a user sensor 180 besides a display unit 110 including a display panel 115 and a controller 120.

According to exemplary embodiments, some of elements shown in FIG. 4 may be omitted or changed, or other elements may be further added. In other words, when the display panel 115 is realized as an OLED panel, the BLU 130 and the backlight driver 140 may be omitted.

The display unit 110 may include the display panel 115 that may be curved at a curvature occurring within a preset range. As described above, the curvature refers to a value that may represent a curved degree at each point of a curved surface.

The display panel 115 included in the display unit 110 may include a plurality of pixels. Here, the plurality of pixels may include R, G, and B pixels. In other words, pixels including R, G, and B pixels may be arranged in a plurality of rows and a plurality of columns to form the display panel 115. An inclusion of R, G, and B pixels in a plurality of pixels is only an exemplary embodiment, and thus the plurality of pixels may include cyan (C), magenta (M), and yellow (Y) sub pixels.

The display panel 115 may be realized as various types of display units such as an LCDP, a PDP, an OLED, a VFD, a FED, an ELD, etc.

The controller 120 is an element that controls an overall operation of the display apparatus 100. In particular, the controller 120 may control the display unit 110 to compensate for an image quality of each area of the display panel 115 based on a curvature that is a curved degree of the display unit 110.

The controller 120 may control brightness of each area of the display panel 115 based on a curvature of the display panel 115 to compensate for an image quality of the display panel 115.

In detail, when the display panel 115 does not additionally include a BLU like an OLED panel, the controller 120 may compensate for a current value of each pixel included in the display panel 115 to control brightness of each area of the display panel 115.

For example, the controller 120 may control the display unit 110 to be divided into a plurality of areas and increase a current value of a current flowing in pixels included in an area that is to be brightened. The controller 120 may also control the display unit 110 to decrease a current value of a current flowing in pixels included in an area that is to be darkened.

Also, when the display panel 115 is realized as a panel such as an LCDP or an LED panel, the display apparatus 100 may include the BLU 130 and the backlight driver 140. Therefore, the controller 120 may control the backlight driver 140 to control brightness of each area of the display panel 115.

In other words, the BLU 130 is an element that provides backlight to the display panel 115. In other words, when the display panel 115 is a non-emitting device that does not autonomously emit light like an LCDP, the BLU 130 may provide light to the display panel 115.

The backlight driver 140 is an element that drives the BLU 130. In detail, the backlight driver 140 may provide a signal for controlling on and/or off of the BLU 130, an intensity of brightness of the BLU 13, etc.

For example, the controller 120 may control the backlight driver 140 so as to enable brightness of the BLU 130 to be brightest in a central area of the display panel 115. The controller 120 may also control the backlight driver 140 so as to enable the brightness of the BLU 130 to be darker as being far away from the central area of the display panel 115.

The controller 120 may control R, G, and B values of pixels included in the display panel 115 in response to the brightness of each area of the display panel 115.

In other words, when the controller 120 controls brightness of an area of a displayed image having a high luminance level to be lowered, the controller 120 may compensate for a pixel value so as to enable the pixel value to increase. Also, when the controller 120 controls brightness of an area of the display image having a low luminance level to increase, the controller 120 may control a pixel value to be lowered.

In detail, the controller 120 may control the display unit 110 to be divided into a plurality of areas and control brightness of each of the plurality of areas to maximize a curvature effect of the display unit 110. Therefore, when pixels included in an area, brightness of which is to be controlled by the controller 120 to be brighter, have low luminance values, the controller 120 may control pixel values to be lowered so as to compensate for the pixel values. However, when the pixels included in the area, brightness of which is to be controlled by the controller 120 to be brighter, have high luminance values, the compensation for the pixel values may be unnecessary.

Also, when pixels included in an area, brightness of which is to be controlled by the controller 120 to be darker, have high luminance values, the controller 120 may control pixel values to be higher in order to compensate for the pixel values. However, when the pixels included in the area, brightness of which is to be controlled by the controller 120 to be darker, have low luminance values, the compensation for the pixel values may be unnecessary.

The controller 120 may provide brightness of each area of the display panel 115 according to a default value pre-stored in the display apparatus 100 but may provide brightness of each area of the display panel 115 according to user settings. In particular, the controller 120 may control the backlight driver 140 to provide different brightness to areas of the display panel 115 so as to increase a curved effect of the display panel 115 that is curved at a preset curvature.

The controller 120 may control the backlight driver 140 to provide different brightness to the areas of the display panel 115 according to types of contents displayed on the display unit 110.

For example, when a content displayed on the display unit 110 is a single-player game, one user may be expected to view the displayed content. Therefore, the controller 120 may control the backlight driver 140 to provide different brightness to the areas of the display panel 115 so as to maximize a curvature effect.

When the content displayed on the display unit 110 is a soccer match, several users may be expected to view the displayed content. An immersion of a user who views a content in an area corresponding to an edge of the display unit 110 may be lowered due to a curvature. Therefore, the controller 120 may control the backlight driver 140 to provide different brightness to the areas of the display panel 115 so as to lower the curvature effect.

However, even when the content displayed on the display unit 110 is the soccer match, one user may view the displayed content. Therefore, the controller 120 may control the backlight driver 140 to provide different brightness to the areas of the display panel 115 according to user settings.

In other words, when the curvature effect is high, the controller 120 determines the content displayed on the display unit 110 as a better content to be viewed. Therefore, even when a central area of the display unit 110 divided into a plurality of areas in a vertical direction becomes brightest, brightness of the display unit 110 becomes darker as being far away from the central area, and the user inputs a command that is not to change brightness or changes settings, the controller 120 may not change the brightness of the display panel 115.

The controller 120 may further include a parameter calculator 125. The parameter calculator 125 may calculate a parameter value for controlling brightness of the BLU 130 varying according to the areas of the display panel 115 and pixel values of pixels.

In other words, the parameter calculator 125 may calculate a parameter value for controlling brightness of the BLU 130. The backlight driver 140 may drive the BLU 130 according to a received parameter value.

The parameter calculator 125 may calculate a parameter value for controlling a pixel value of each pixel. Therefore, the parameter calculator 125 may transmit the calculated parameter value for controlling the pixel value to the panel driver 160.

In detail, when the brightness of the BLU 130 is lowered, the parameter calculator 125 may calculate a parameter value for increasing a pixel value of an area of a displayed image having a high luminance level.

Also, when the brightness of the BLU 130 becomes higher, the parameter calculator 125 may calculate a parameter value for lowering a pixel value of an area of the display image having a low luminance level.

In other words, the parameter calculator 125 may calculate a parameter value for compensating for a pixel value according to brightness of the BLU 130 in order to brighten the brightness of the BLU 130 and reduce an inconvenience that the user may feel.

The image processor 150 may process image data to generate frame data that is displayed through the display unit 110. In particular, the image processor 150 may scale an image according to a curvature of the display panel 115 that is curved and brightness of each area.

For example, when a curvature effect of the display panel 115 that is curved is minimized according to types of contents or user settings, the controller 120 may control the backlight driver 140 so as to enable brightness of a central area of the display panel 115 to be darkest and enable brightness of the display panel 115 to be brighter as being far away from the central area of the display panel 115.

Here, the image processor 150 may also be controlled by the controller 120 to minimize the curvature effect of the display panel 115 so as to scale image data that enables a displayed image to like it is displayed on the display panel 115 having a curvature of 0.

The panel driver 160 is an element that drives the display panel 115. In other words, the panel driver 160 may drive the display panel 115 to display frame data processed by the image processor 150.

The panel driver 160 may also drive the display panel 115 to change a pixel value of each pixel according to a parameter value calculated by the parameter calculator 125.

The storage unit 170 may store an operating system (O/S) for driving the display apparatus 100, software and firmware for performing various functions, an application, a content, setting information input or set by a user when executing an application, characteristic information indicating a characteristic of the display apparatus 100 or the like, etc.

The storage unit 170 stores various types of modules for driving the display apparatus 100. For example, the storage unit 170 may store software including a base module, a sensing module, a communication module, a presentation module, a web browser module, and a service module. Here, the base module is a base module that processes signals transmitted from respective pieces of hardware included in the display apparatus 100 and transmits the processed signals to an upper layer module. The sensing module may collect information from various types of sensors, analyze and manage the collected information, and may include a face recognition module, a voice recognition module, a motion recognition module, a near field communication (NFC) module, etc. The presentation module is a module that forms a display screen and may include a multimedia module for playing and outputting a multimedia content and a user interface (UI) rendering module for processing a UI and a graphic. The service module is a module that includes various types of applications for providing various services.

As described above, the storage unit 170 may include various types of program modules, but some of the various types of program modules may be omitted, changed, or added according to a type and a characteristic of the display apparatus 100. For example, when the display apparatus 100 described above is realized as a smartphone, the base module may further include a position determiner module for determining a global positioning system (GPS)-based position, and the sensing module may further include a sensing module for sensing a motion of the user.

The user sensor 180 is an element that senses the user. For example, the user sensor 180 may include at least one selected from various elements for sensing the user such as a camera (not shown), a passive infrared (PIR) sensor, and an infrared (IR) sensor. In other words, the user sensor 180 may sense a position of the user, who uses the display apparatus 100, by using an element for sensing the user.

The controller 120 may control brightness of areas of the display panel 115 according to the position of the user sensed by the user sensor 180.

In detail, when the display panel 115 includes the BLU 130, the controller 120 may control the brightness of the BLU 130 to change according to the position of the user sensed by the user sensor 180. For example, the controller 120 may control the backlight driver 140 so as to enable brightness of the BLU 130 to be bright in an area of the display panel 115 close to the position of the user sensed by the user sensor 180 and enable the brightness of the BLU 130 to be darker as being far away from an area of the display panel 115 having bright brightness.

The user sensor 180 may also sense a distance between the display apparatus 100 and the user besides the position of the user. For example, the user sensor 180 may include a distance sensor that measures the distance between the display apparatus 100 and the user according to various methods such as an IR using method, a natural light using method, an ultrasonic method, etc.

Therefore, when the user sensor 180 senses that the user keeps a threshold distance or more from the display panel 115, the controller 120 may control an intensity of the brightness of the BLU 130 to increase.

Through the display apparatus 100 as described above, the user may control brightness of backlight to feel an effect as when a curvature is controlled although the curvature of the display apparatus 100 that is curved is not controlled.

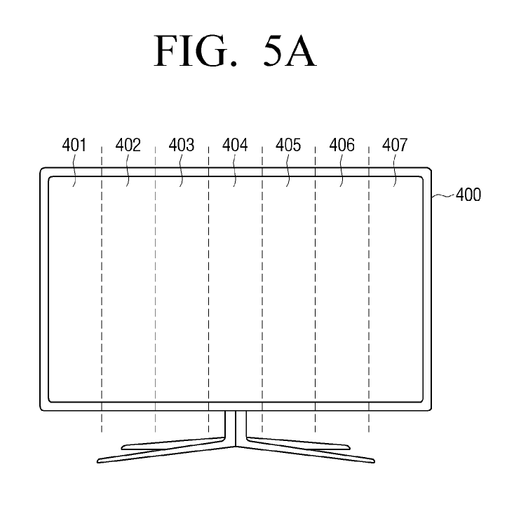

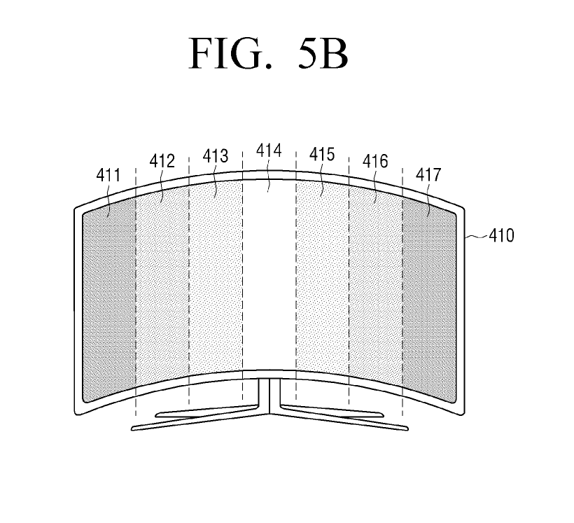

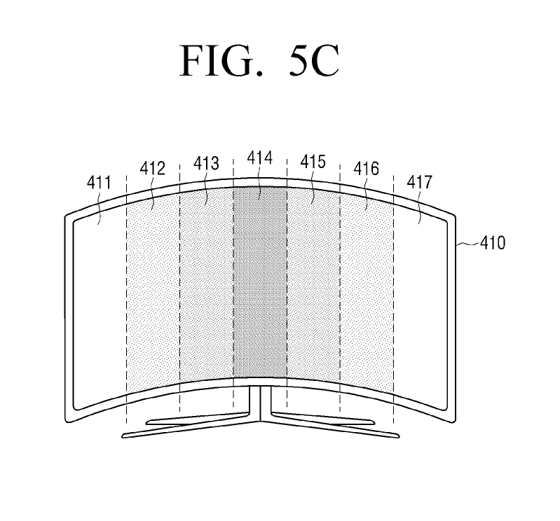

A method of controlling brightness of the display panel 115 will now be described in detail with reference to FIGS. 5A through 5C.

FIG. 5A illustrates a display apparatus 400 including the display panel 115 that is flat to have a curvature of approximately 0. In general, brightness of backlight may be equally realized in all areas of the display apparatus 400 including the display panel 115 that is flat to have the curvature of approximately 0. Alternatively, the controller 120 may control a current value of a pixel value of the display panel 115 to be constant so as to enable brightness of the display panel 115 to be uniform.

In other words, as shown in FIG. 5A, the display panel 115 of the display apparatus 400 may be divided into a plurality of areas, such as first through seventh areas 401 through 407, in a vertical direction. When brightness of backlight is controlled in each of the areas, brightness of each of the areas of the display panel 115 may be equally controlled.

As shown in FIGS. 5B and 5C, a display apparatus 410 including a display panel that is curved at a preset curvature may control brightness of each area of the display panel.

The display panel of the display apparatus 410 shown in FIGS. 5B and 5C is divided into seven areas in a vertical direction, but this is only an exemplary embodiment. Therefore, the display panel may be divided into various numbers of areas in various directions.

Shadows displayed on a panel part of the display apparatus 410 shown in FIGS. 5B and 5C indicate brightness of the respective areas of the display panel.

In other words, as shown in FIG. 5B, in the display apparatus 410 including the display panel that is curved at a preset curvature, brightness of a central area 414 of the display panel may be controlled to be brightest, and brightness of areas 413 and 415 positioned next to both sides of the central area 414 may be controlled to be darker than the central area 414. In other words, the display apparatus 410 may control a current value of each pixel or control brightness of backlight to be darker as being away from the central area 414 of the display panel.

As shown in FIG. 5B, when the brightness of the central area 414 of the display panel is controlled to be brightest, and the brightness of the backlight is controlled to be darker as being far away from the central area 414, a user who views an image through the display apparatus 410 may feel as when the user views the image through a display panel having a larger curvature than an actual curvature of the display panel of the display apparatus 410 that is curved. Therefore, even when a curvature of the display apparatus 410 is determined in advance, there may occur an effect as when the curvature of the display apparatus 410 is flexibly changed within a preset range according to brightness of the BLU.

On the contrary, as shown in FIG. 5C, in the display apparatus 410 including the display panel that is curved at a preset curvature, brightness of the central area 414 of the display panel may be controlled to be brightest, and brightness of the areas 413 and 415 positioned next to both sides of the central area 414 may be controlled to be brighter than the central area 414. In other words, the display apparatus 410 may control a current value of each pixel to increase or may control brightness of backlight to be brighter as being far away from the central area 414 of the display panel.

As shown in FIG. 5C, when the brightness of the central area 414 of the display panel is controlled to be darkest, and brightness of the display panel is controlled to be brighter as being far away from the central area 414, a user who views an image through the display apparatus 410 may feel as when the user views the image through a display panel having a smaller curvature than an actual curvature of the display panel of the display apparatus 100 that is curved. Therefore, even when a curvature of the display apparatus 410 is determined in advance, there may occur an effect as when the curvature of the display apparatus 410 is flexibly changed within a preset range according to brightness of the backlight.

The display apparatus 100 may control the display panel 115 to provide different brightness to areas of the display panel 115 according to a type of a content displayed through the display panel 115, user settings, a curvature of the display panel 115, etc.

In detail, the parameter calculator 125 of the display apparatus 100 may calculate a parameter value for controlling brightness of each area of the display panel 115 according to a preset curvature of the display panel 115, information about a user, a type of a displayed content (e.g., information about whether a content is appropriate to be displayed through a display panel having a large curvature or is appropriate to be viewed by a plurality of users), etc. The parameter calculator 125 may be realized as a type such as a hardware device, a module, a chip, or the like that is additionally included in the display apparatus 100. The parameter calculator 125 may also be software, a program, or an application that is stored in the display apparatus 100.

Alternatively, the display apparatus 100 may store a parameter value, which is for controlling brightness of an appropriate area of the display panel 115 according to a curvature of the display panel 115, as a default value. In general, the display apparatus 100 may store a parameter value, which is for controlling brightness of a central area of the display panel 115 to be brightest and controlling brightness of backlight to be darker as being far away from the central area of the display panel 115, as a default value so as to maximize a curvature effect of the display panel 115.

The display apparatus 100 may also store a parameter value that is pre-calculated to be appropriate for various cases.

The display apparatus 100 may transmit a parameter value for controlling brightness of the BLU 130 to the backlight driver 140. The backlight driver 140 that receives the parameter value may control brightness of the BLU 130 according to the received parameter value and areas.

On the contrary, the display apparatus 100 may calculate a parameter value for controlling brightness of each area of the display panel 115 and a parameter value for controlling pixel values of pixels included in the display panel 115.

A method of calculating parameter values for controlling brightness of the display panel 115 and pixel values to compensate for pixel values of the display panel 115 is as described above.

The display apparatus 100 may transmit the parameter value for controlling the pixel values to the panel driver 160. The panel driver 160 that receives the parameter value may compensate for pixel values of pixels included in the display panel 115 according to the received parameter value.

The BLU 130 as described above is essential when the display panel 115 is an LCDP so as to enable pixels included in the display panel 115 to be non-emitting bodies. When the display panel 115 is realized as a light-emitting body such as a PDP, an OLED, or an LED panel, and thus the BLU 130 is not included, the display apparatus 100 may control brightness of each pixel included in the display panel 115. In other words, the display apparatus 100 may control brightness of pixels included in each area of the display panel 115 to be different from one another. In detail, the display apparatus 100 may control a current value of a current flowing in each pixel of the display panel 115 that is realized as a light-emitting body, to control light generated in each pixel.

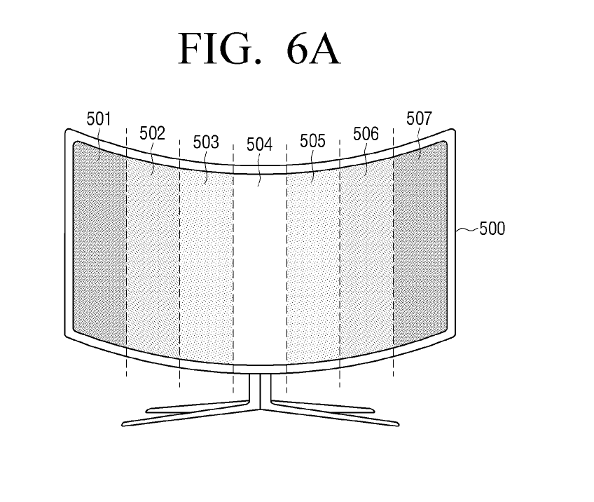

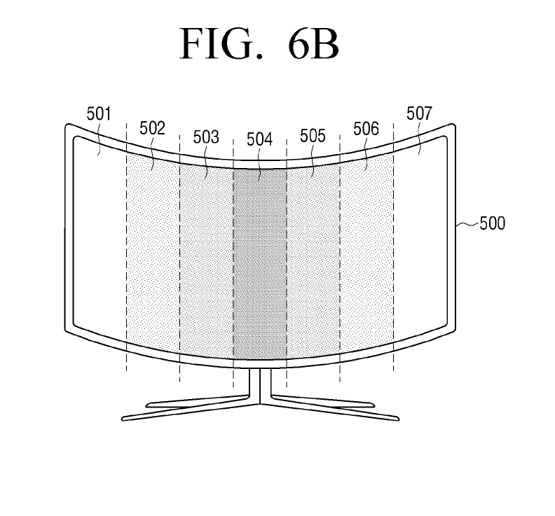

FIGS. 6A and 6B illustrate a display apparatus 500 that is curved so as to enable a central area 504 of a display panel protrude most forward with respect to other areas 501, 502, 503, 505, 506 and 507, according to an exemplary embodiment of the present disclosure.

As shown in FIG. 6A, the display apparatus 500 may control brightness of the central area 504 protruding most forward to be brightest in order to maximize a curved effect of the display panel of the display apparatus 500. The display apparatus 500 may also control brightness of the display panel to be darker as being far away from the central area 504.

As shown in FIG. 6B, the display apparatus 500 may control brightness of the central area 504 protruding most forward to be darkest in order to maximize a curved effect of the display panel of the display apparatus 500. The display apparatus 500 may also control brightness of the display panel to be brighter as being away from the central area 504.

As shown in FIGS. 5B and 6B, brightness of the display panels of the display apparatus 410 and 500 may be changed to be symmetric based on central areas. However, this is only an exemplary embodiment, and thus the display apparatuses 410 and 500 may control brightness of edges of the display panels or the areas close to side of the display panel to be brightest or darkest or control brightness of the display panels to be gradually darker or brighter as being far away from the edges.

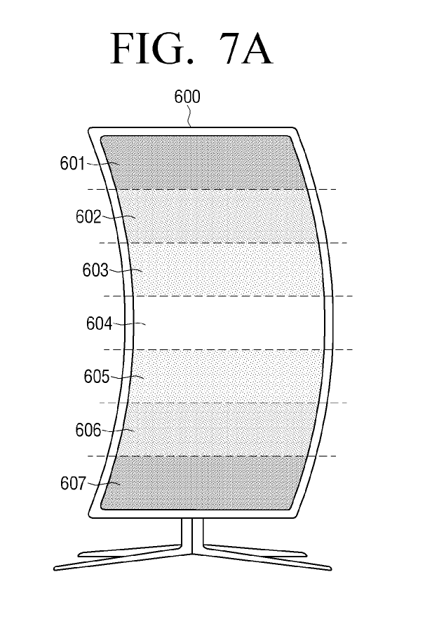

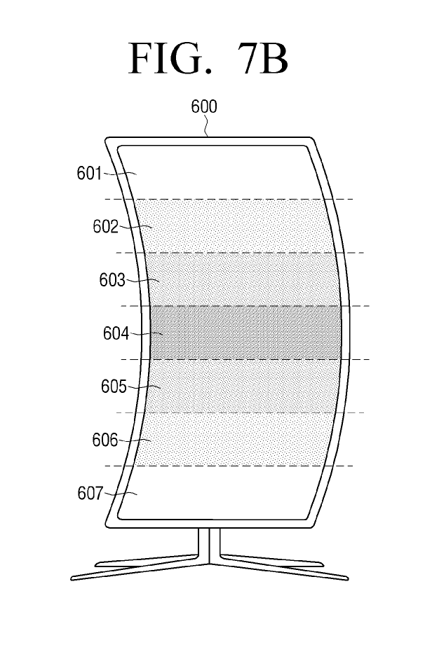

FIGS. 7A and 7B illustrate a display apparatus 600 that is realized in a rectangular shape and includes a display panel having a vertical length longer than a horizontal length thereof, according to an exemplary embodiment of the present disclosure.

A central area 604 of the display panel protrudes in a direction toward which a user looks at the display panel, but this is only an exemplary embodiment. Therefore, the central area 604 of the display panel may protrude in an opposite direction to a direction toward which the user looks at the display panel.

The display panel of the display apparatus 600 shown in FIGS. 7A and 7B is divided into seven areas in a horizontal direction, but this is only an exemplary embodiment. Therefore, the display panel of the display apparatus 600 may be divided into various numbers in various directions.

Shadows displayed in a panel part of the display apparatus 600 shown in FIGS. 7A and 7B indicate brightness of respective areas of the display panel.

In detail, as shown in FIG. 7A, the display apparatus 600 including the display panel that is curved at a preset curvature may control brightness of the central area 604 of the display panel to be brightest and control brightness of areas 603 and 604 positioned next to both sides of the central area 604 to be darker than the central area 604. In other words, the display apparatus 600 may control brightness to be darker as being far away from the central area 604. For example, the areas 601,607 are more darker than the areas 602, 606 which are more darker the areas 603, 605.

As shown in FIG. 7A, when the brightness of the central area 604 of the display panel is controlled to be brightest, and brightness of backlight is controlled to be darker as being far away from the central area 604, a user who views an image through the display apparatus 600 may feel as when the views the image through a display panel having a larger curvature than an actual curvature of the display panel of the display apparatus 600 that is curved. Therefore, even when a curvature of the display apparatus 600 is determined in advance, there may occur an effect or visual effect as when the curvature of the display apparatus 600 is flexibly changed within a preset range according to brightness of the display panel.

On the contrary, as shown in FIG. 7B, the display apparatus 600 including the display panel that is curved at a preset curvature may control brightness of the central area 604 to be darkest and control brightness of the areas 603 and 605 positioned next to both sides of the central area 604 to be brighter than the central area 604. In other words, the display apparatus 600 may control brightness of backlight to be brighter as being far away from the central area 604 of the display panel.

As shown in FIG. 7B, when the brightness of the central area 604 of the display panel is controlled to be darkest, and the brightness of the backlight is controlled to be brighter as being far away from the central area 604, a user who views an image through the display apparatus 600 may feel as if the user views the image through a display panel having a smaller curvature than an actual curvature of the display panel of the display apparatus 600 that is curved. Therefore, even if the curvature of the display apparatus 600 is determined in advance, there may occur an effect as if the curvature of the display apparatus 600 is flexibly changed within a preset range according to brightness of the backlight.

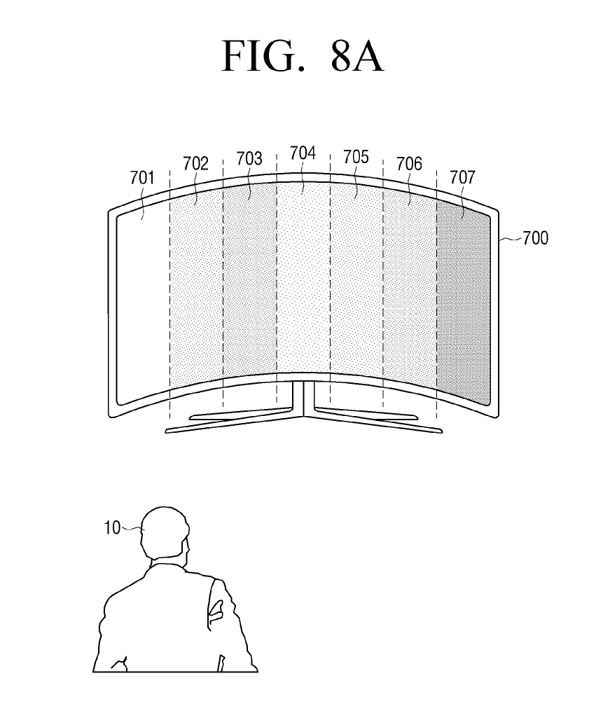

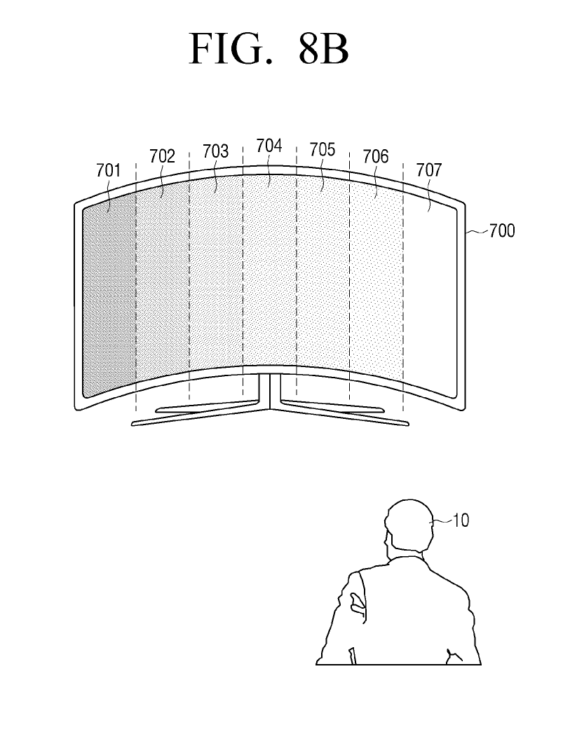

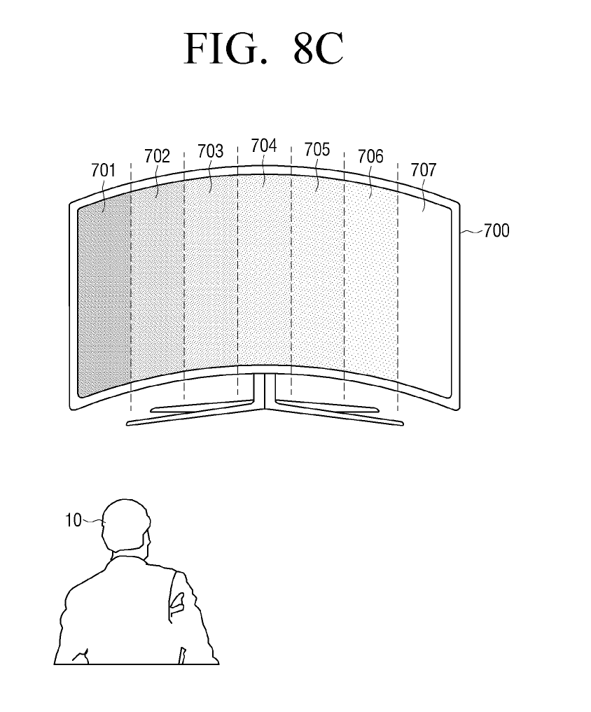

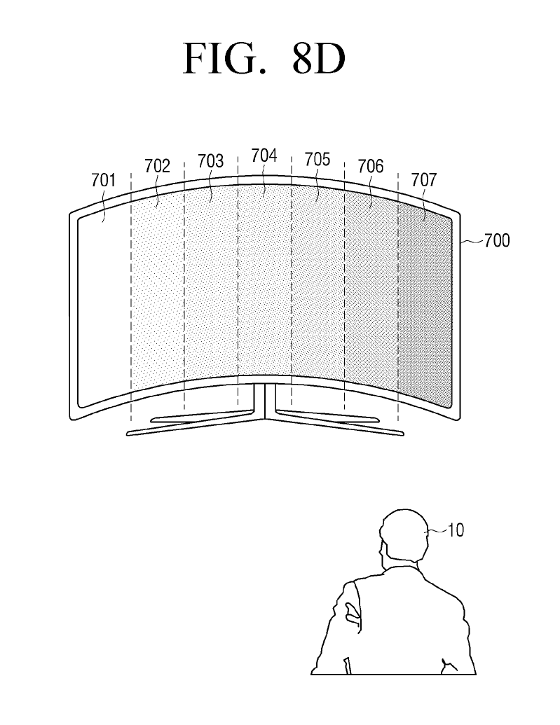

FIGS. 8A through 8C illustrate brightness of each area of a display panel that is controlled according to a position of a user 10, according to an exemplary embodiment of the present disclosure.

A display apparatus 700 may include a user sensor 180 that senses a position of the user 10 and a distance between the user 10 and the display apparatus 700. For example, the user sensor 180 may sense the distance between the user 10 and the display apparatus 700 through various types of apparatuses such as at least one sensor selected from a camera for capturing the user 10, an Passive Infrared (PIR) sensor for sensing an existence of the user 10, and a proximity sensor, a distance sensor for measuring the distance between the display apparatus 700 and the user 10, etc.

As shown in FIG. 8A, when it is sensed that the user 10 is positioned in a left direction to look at the display apparatus 700, the display apparatus 700 may control brightness of backlight so as to enable brightness of an area of a display panel corresponding to a distance close to the user 10 to be brightest.

In other words, when it is determined that the user 10 is positioned in front of first and second areas 701 and 702 of areas of the display panel that is divided into seven areas in a vertical direction, the display apparatus 700 may control brightness of backlight to so as to enable brightness of the first area 701 of the display panel to be brightest and enable the brightness of the backlight to be darker as being away from the first area 701.

As shown in FIG. 8B, when it is sensed that the user 10 is positioned in a right direction to look at the display apparatus 700, the display apparatus 700 may control brightness of the backlight so as to enable brightness of an area of the display panel corresponding to a direction close to the user 10 to be brightest.

In other words, when it is determined that the user 10 is positioned in front of sixth and seventh areas 706 and 707 of the areas of the display panel that is divided into the seven areas in the vertical direction, the display apparatus 700 may control the brightness of the backlight to so as to enable brightness of the seventh area 707 to be brightest and enable the brightness of the backlight to be darker as being far away from the seventh area 707.

The display apparatus 100 may control brightness of one of a plurality of areas of the display panel close to the user 10 to be brightest. Therefore, although the user 10 who views a content through the display apparatus 100 views a content in any position, the user 10 may feel a deeper immersion or a depth in the display apparatus 100.

The display apparatus 100 may also sense whether the distance between the display apparatus 100 and the user 10 keeps a threshold distance or more. In detail, when it is sensed that the user 10 is at a threshold distance or more from the display apparatus 100, the display apparatus 100 may control the brightness of a BLU to be brighter than when the user 10 is within the threshold distance.

For example, when it is sensed that the threshold distance is set to 5 m, and the user 10 is at a distance of 5 m or more from the display apparatus 100, the display apparatus 100 may control the BLU so as to enable brightness of the display panel to be, for example, approximately 1.3 times brighter. Here, the display apparatus 100 may control the brightness of the display panel to be approximately 1.3 times brighter. In other words, the display apparatus 100 may control brightness of a brightest area to be approximately 1.3 times brighter from current brightness and control brightness of a darkest area to be approximately 1.3 times brighter from current brightness.

FIGS. 8C and 8D illustrate the display apparatus 700 that controls brightness of one of a plurality of areas of a display panel close to the user 10 to be darkest, according to an exemplary embodiment of the present disclosure.

As shown in FIG. 8C, when it is sensed that the user 10 is positioned in a left direction to look at the display apparatus 700, the display apparatus 700 may control brightness of the BLU so as to enable brightness of an area of the display panel corresponding to a direction close to the user to be darkest.

In other words, when it is determined that the user 10 is positioned in front of the first and second areas 701 and 702 of the areas of the display panel that is divided into the seven areas in the vertical direction, the display apparatus 700 may control brightness of the first area 701 of the display panel to be darkest and control brightness of the BLU to be brighter as being far away from the first area 701.

As shown in FIG. 8D, when it is sensed that the user 10 is positioned in a right direction to look at the display apparatus 700, the display apparatus 700 may control brightness of an area of the display panel corresponding to a direction close to the user 10 to be darkest.

In other words, when it is determined that the user 10 is positioned in front of the sixth and seventh areas 706 and 707 of the areas of the display panel that is divided into the seven areas in the vertical direction, the display apparatus 700 may control brightness of the seventh area 707 to be darkest and control brightness of backlight to be brighter as being far away from the seventh area 707.

When a user who feels inconvenience as to the display panel that is curved at a preset curvature views a content through the display apparatus 700 or it is determined that a content inappropriate to be displayed through the curved display panel is displayed, according to user settings, the display apparatus 700 may control brightness of the display panel corresponding to a direction close to the user 10 to be darkest and control the brightness of the display panel to be brighter as being far away from the direction close to the user as shown in FIGS. 8C and 8D.

The display panel 115 of the display apparatus 100 as described above may be curved at a preset curvature. However, the display unit 110 may further include a support unit (not shown) that supports the display panel 115, and the support unit may control the display panel 115 to be curved at a preset curvature.

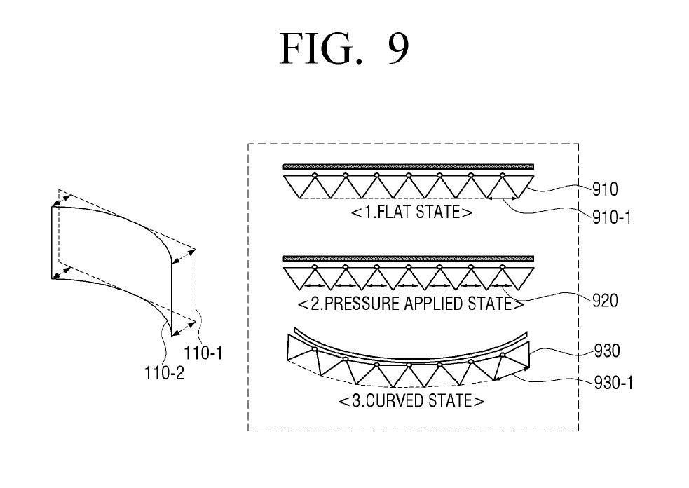

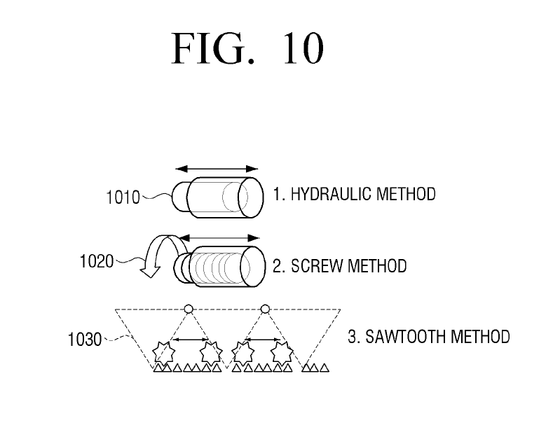

The display panel 115 may be curved at a curvature occurring within a preset range. In other words, the display panel 115 may be realized as a variable type. A method of changing a display panel will now be described in detail with reference to FIGS. 9 and 10.

FIG. 9 illustrates a structure of a display unit according to an exemplary embodiment of the present disclosure.

Referring to FIG. 9, the display unit 110 may be curved into a curved surface state 110-2 from a flat state 110-1.

In detail, the display unit 110 may include a plurality of blocks 910 that are arranged to keep a preset distance 910-1 from one another, and the controller 120 may apply a pressure 920 between a plurality of blocks.

Here, the plurality of blocks 910 have triangular cross-sections and share one apex. Therefore, when the controller 120 applies the pressure 920 between a plurality of blocks 930, distances 930-1 between the plurality of blocks 930 that receive a pressure may increase. Therefore, the plurality of blocks 930 may have a curved shape.

According to the above-described exemplary embodiment, the controller 120 may apply a pressure having a size corresponding to a determined curvature between a plurality of blocks to change a curvature of the display unit 110.

FIG. 10 illustrates a method of applying a pressure according to an exemplary embodiment of the present disclosure.

Referring to FIG. 10, the pressure 910 applied between a plurality of blocks may be generated by a hydraulic method 1010, a screw method 1020, or a sawtooth method 1030.

The hydraulic method 1010 is a method of controlling a pressure 1020 applied between a plurality of blocks according to an amount of oil, water, or air flowing into the plurality of blocks. The screw method 1020 is a method of controlling the pressure 1020 applied between the plurality of blocks according to a rotation amount of a motor by using the motor. The sawtooth method 1030 is a method of adding a chain on sawteeth installed between the plurality of blocks to control the number of rotations of sawteeth so as to control the pressure 1020 applied between the plurality of blocks.

The generation of the pressure 1020 applied between the plurality of blocks is not limited to the above-described exemplary embodiment.

Also, the display unit 110 may include a plurality of small motors, and the controller 120 may respectively control the plurality of small motors to curve left and/or right sides of the display unit 110 so as to change a curvature of the display unit 110.

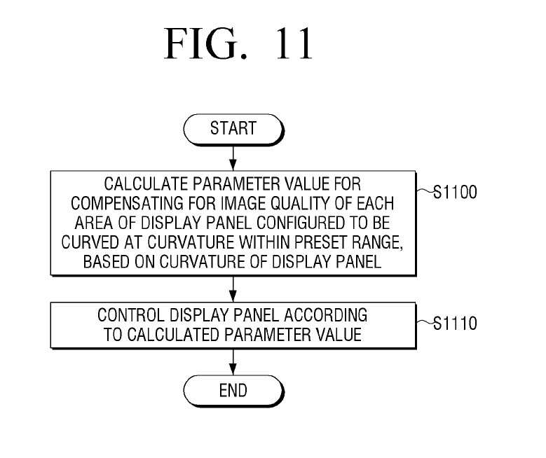

FIG. 11 is a flowchart of a method of controlling a display apparatus according to an exemplary embodiment of the present disclosure.

In operation S1100, the display apparatus 100 calculate a parameter value for compensating for an image quality of each area of a display panel that may be curved at a curvature occurring within a preset range, based on a curvature of the display panel. In operation S1110, the display apparatus 100 controls the display panel according to the calculated parameter value.

In detail, the display apparatus 100 may set the display panel to a plurality of areas of a BLU, brightness of which are to be simultaneously controlled, according to initial settings or user settings. For example, the display apparatus 100 may set the display panel to five areas having the same widths in a vertical direction and control brightness of the five areas.

In particular, the display apparatus 100 may calculate a parameter value to control brightness of each area of the display panel according to initial settings, etc. depending on user settings, content types, a curvature that is a curved degree of the display panel, etc.

The display apparatus 100 may store a parameter value calculated according to each situation. When the same situation occurs, the display apparatus 100 may rapidly control brightness of each area of the display panel according to the stored parameter value.

In detail, in order to maximize a curved effect of the display panel according to a curvature of the display panel and increase an immersion of a user, the display apparatus 100 may control a current value of pixels included in a central area of the display panel to increase so as to enable the central area of the display panel to be brighter and enable the current value to decrease as being far away from the central area of the display panel, so as to control the display panel to be gradually darker.

Also, when the display panel is realized as a non-emitting body and thus includes a BLU and a backlight driver, the display apparatus 100 may control the backlight driver so as to enable brightness of the BLU to be brightest in the central area of the display panel and to be darker as being far away from the central are of the display panel.

Alternatively, when a curvature effect of the curved display panel is minimized according to types of contents, user settings, or the like, the display apparatus 100 may control brightness of the central area of the display panel to be darkest and the brightness of the BLU to be brighter as being far away from the central area of the display panel.

The display apparatus 100 may control brightness of each area of the display panel according to a position of a user and a distance between the user and the display apparatus 100.

For example, when it is sensed that the user is positioned in a left direction to look at the display apparatus 100, the display apparatus 100 may control the display panel so as to brightness of an area of the display panel corresponding to a direction close to the user to be brightest in order to increase an immersion of the user.

Also, when it is sensed that the distance between the display apparatus 100 and the user is a threshold distance or more, the display apparatus 100 may control brightness of the display panel to be preset times brighter in a whole area of the display panel.

The display apparatus 100 may control brightness of backlight so as to brightness of the display panel corresponding to a direction, where the user is sensed, to be darkest. In other words, when the curved display panel is inappropriate to display a content according to user settings or types of contents, the display apparatus 100 may control the brightness of the display panel corresponding to the direction, where the user is sensed, to be darkest and relieve a curved effect of the display panel.

The above-described elements of the display apparatus 100 may be realized as software. For example, although not shown in FIGS. 3 and 4, the display apparatus 100 may further include a flash memory or other nonvolatile memories. Programs respectively corresponding to the elements may be stored on such a non-volatile memory.

Also, the controller 120 may be realized as a type including a central processing unit (not shown) and a random access memory (RAM). The CPU of the controller 120 may copy the programs stored in the non-volatile memory into the RAM and execute the copied programs to control brightness of a plurality of areas of a display panel as described above.

A method of controlling a display apparatus according to various exemplary embodiments as described above may be coded as software and then stored on a non-transitory computer-readable medium. The non-transitory computer-readable medium may be mounted and used on various types of devices.

The non-transitory computer-readable medium is a medium which does not store data temporarily such as a register, cash, and memory but stores data semi-permanently and is readable by devices. More specifically, the aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting the present disclosure. The present teaching may be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A display apparatus comprising:
a display unit comprising a display panel configured to be curved at a preset curvature; and
a controller to control the display unit to compensate for an image quality of at least one area of the display panel based on the curvature of the display panel.

2. The display apparatus of claim 1, wherein the controller compensates for a current value of pixels comprised in the display panel to control brightness of the at least one area of the display panel based on the curvature of the display panel.

3. The display apparatus of claim 1, further comprising:
a backlight unit (BLU) to provide backlight to the display panel; and
a backlight driver to drive the BLU,
wherein the controller controls the backlight driver to control brightness of the at least one area of the display panel based on the curvature of the display panel.

4. The display apparatus of claim 2, wherein the controller controls red (R), green (G), and blue (B) values of pixels comprised in the display panel in response to the brightness of the area of the display panel.

5. The display apparatus of claim 1, wherein the controller controls the display unit to adjust brightness of a central area of the display panel to be brightest and adjust brightness the other areas of the display panel so that brightness of the areas that are farther away from the central area of the display panel to be more darker than brightness of the central area.

6. The display apparatus of claim 1, further comprising:
a user sensor to sense a position of a user from the display unit,
wherein the controller controls brightness of the at least one area of the display panel according to the position of the user sensed through the user sensor.

7. The display apparatus of claim 1, wherein the controller controls brightness of the at least one area of the display panel according to user settings.

8. The display apparatus of claim 1, wherein the controller controls brightness of the at least one area of the display panel according to a type of a content displayed on the display unit.

9. The display apparatus of claim 1, wherein the controller divides the display panel into a plurality of areas in a vertical direction and controls brightness of at least one of the area of the plurality of areas.

10. A method of controlling a display apparatus, the method comprising:
determining a parameter value for compensating for an image quality of at least one area of a display panel configured to be curved at a preset curvature based on the curvature of the display panel; and
controlling the display panel according to the determined parameter value.

11. The method of claim 10, wherein the controlling of the display panel comprises compensating for a current value of pixels comprised in the display panel to control brightness of the at least one area of the display panel based on the curvature of the display panel.

12. The method of claim 10, wherein the controlling of the display panel comprises controlling a backlight driver configured to drive a BLU, so as to adjust the BLU to provide brightness of the at least one area of the display panel based on the curvature of the display panel.

13. The method of claim 11, further comprising:
controlling R, G, and B values of pixels comprised in the display panel in response to the brightness of the at least one area of the display panel.

14. The method of claim 10, wherein the controlling of the display panel comprises controlling brightness of a central area of the display panel to be brightest and controlling brightness of the other areas of the display panel so that brightness of the areas that are farther away from the central area of the display panel to be more darker than the brightness of the central area of the display panel.

15. The method of claim 10, further comprising:
sensing a position of a user of the display panel from the display apparatus,
wherein the controlling of the display panel comprises controlling brightness of the at least one area of the display panel according to the position of the sensed user.

16. The method of claim 10, wherein the controlling of the display panel comprises controlling brightness of the at least one area of the display panel according to user settings.

17. The method of claim 10, wherein the controlling of the display panel comprises controlling brightness of the at least one area of the display panel according to a type of a content displayed on the display apparatus.

18. The method of claim 10, wherein the controlling of the display panel comprises dividing the display panel into a plurality of areas in a vertical direction and controlling brightness of the at least one of the plurality of areas.

19. The display apparatus of claim 6, wherein the controller controls the display unit to adjust brightness of the area of the display panel which is closest to the sensed position of the user to be brightest and adjust brightness of the other areas of the display panel to be more darker.

20. The display apparatus of claim 19, wherein the controller controls the display unit to adjust brightness of the other areas of the display panel to be gradually darker as the other areas are father away from the area having the brightest brightness.

21. The method of claim 15, wherein the controlling of the display panel further comprises controlling brightness of the area of the display panel which is closest to the sensed position of the user to be brightest and brightness of the other areas of the display panel to be more darker.
